(19) United States
(12) Patent Application Publication
(10) Pub. No.: US 2011/0014887 A1
(43) Pub. Date: Jan. 20, 2011

(54) INTERFERENCE CANCELLATION

(75) Inventor: Shousheng HE, Sodra Sandby (SE)

Correspondence Address: BLANK ROME LLP, WATERGATE, 600 NEW HAMPSHIRE AVENUE, N.W., WASHINGTON, DC, 20037, US

(73) Assignee: Cambridge Silicon Radio Limited, Cambridge (GB)

(21) Appl. No.: 12/827,407

(22) Filed: Jun. 30, 2010

(30) Foreign Application Priority Data
Jul. 20, 2009 (GB) 0912585.7

(51) Int. Cl. H04B 1/10

(52) U.S. Cl. 455/296

(57) ABSTRACT

A receiver (10) for receiving a signal transmitted through a propagation channel, the receiver (10) comprising an antenna (12) for receiving the signal, a processor (14) for processing the received signal and a filter (16) for filtering the received signal, wherein the processor (14) is configured to calculate coefficients for configuring the filter (16) and an estimated channel impulse response for the propagation channel.

The present invention relates to a method and apparatus for reducing interference in a received signal.

In a wireless cellular communications network to which a finite amount of spectrum is allocated, the capacity of the network is typically limited by the amount of spectrum available. In such networks the spectrum is typically re-used, such that users in different cells of the network are allocated the same portion of the available frequency spectrum. This gives rise to so-called “co-channel interference (CCI)”, which is interference generated by other users in the network using the same portion of the available frequency spectrum, but in a neighbouring cell.

Techniques have been developed to suppress CCI, but many of these do not meet the requirements specified in release 6 of the third generation partnership protocol (3GPP) standard. One class of CCI suppression techniques is single antenna interference cancellation (SAIC), which is characterised by modelling interference as spatio-temporally coloured noise. A number of SAIC methods are known, but each suffers from distinct disadvantages such as poor performance in multipath environments or increased equaliser complexity. Additionally, these methods all require an adaptive mechanism to be built into the receiver so that in the absence of interference the received signal does not undergo processing to cancel interference, which could degrade the received signal.

According to a first aspect of the invention there is provided a receiver for receiving a signal transmitted through a propagation channel, the receiver comprising an antenna for receiving the signal, a processor for processing the received signal and a filter for filtering the received signal, wherein the processor is configured to calculate coefficients for configuring the filter and an estimated channel impulse response for the propagation channel.

By using the processor to calculate an estimated channel impulse response as well as coefficients for configuring the filter, the configuration of the filter can change to compensate for variable propagation channel conditions.

The filter coefficients and estimated channel impulse response may be calculated in a single operation.

The processor may be configured to calculate the coefficients for configuring the filter on the basis of a known sequence contained in the transmitted signal.

The known sequence may comprise a training sequence.

The processor may be configured to calculate filter coefficients which minimise the difference between the filtered received signal and an expected interference-free received signal.

The filter may comprise a Wiener filter.

According to a second aspect of the invention there is provided a method for reducing interference in a signal received by a receiver through a propagation channel, the method comprising calculating filter coefficients for a filter and an estimated channel impulse response for the propagation and configuring the filter using the coefficients so calculated such that the received signal can be filtered by the filter to reduce interference.

The filter coefficients and estimated channel impulse response may be calculated in a single operation.

The coefficients for configuring the filter may be calculated on the basis of a known sequence contained in the transmitted signal.

The known sequence may comprise a training sequence.

Filter coefficients which minimise the difference between the filtered received signal and an expected interference-free received signal may be calculated.

The filter may comprise a Wiener filter.

Embodiments of the invention will now be described, strictly by way of example only, with reference to the accompanying drawings, of which:

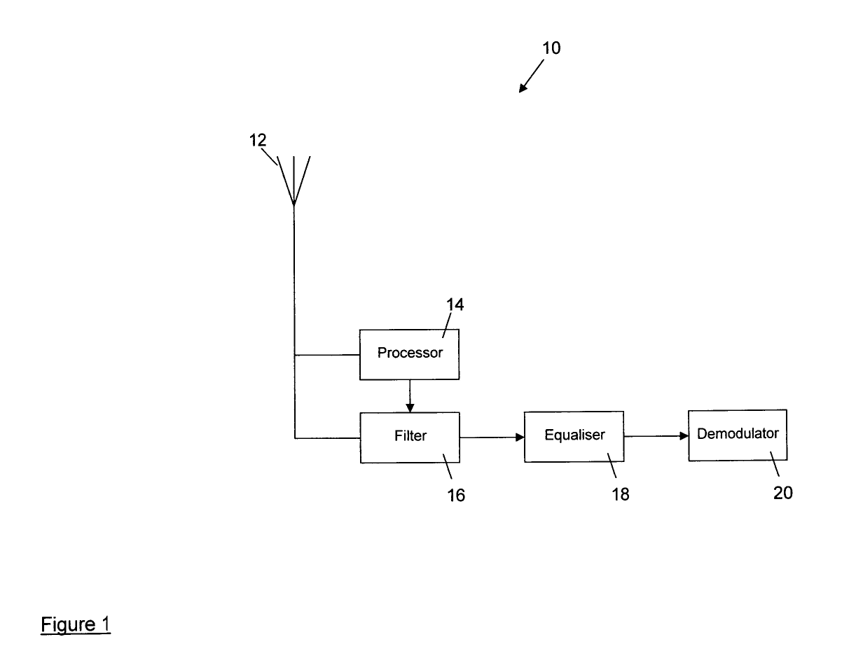

FIG. 1 is a schematic illustration showing elements of a receiver; and

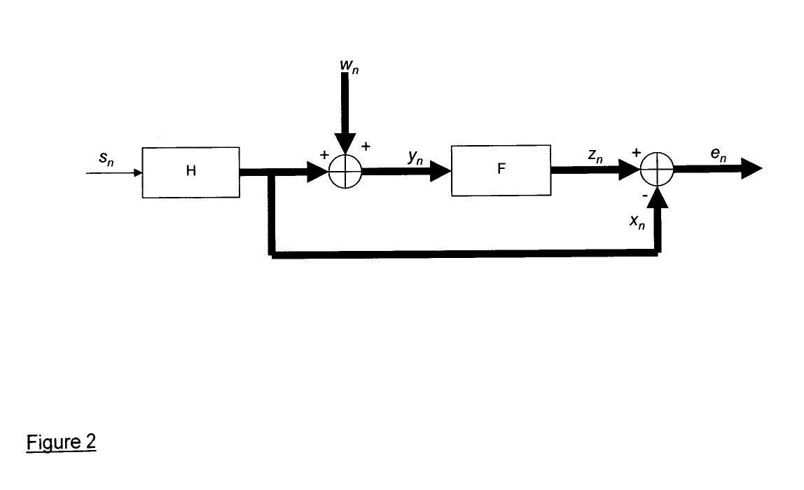

FIG. 2 illustrates a model of a propagation channel and interference cancellation system employed in an embodiment of the present invention.

Referring first to FIG. 1, a receiver architecture is shown generally at 10. It will be appreciated that the functional blocks shown in FIG. 1 are not necessarily representative of physical components of a receiver, but are used only for the purpose of illustrating the invention. Moreover, for reasons of clarity and brevity only those components of the receiver 10 which are relevant to the invention are illustrated, but it will be apparent to those skilled in the art that the receiver 10 comprises additional components.

The receiver 10 comprises an antenna 12 through which a signal can be received. The received signal is passed in parallel to a processor 14 and a Wiener filter 16. The processor 14 is configured to calculate coefficients of the Wiener filter 16, as will be explained in more detail below, such that the Wiener filter is able to cancel, or at least reduce, any interference present in the signal received at the antenna 12. As the propagation environment is likely to change dynamically, the processor 14 is configured to generate a new set of coefficients from time to time as required, to compensate for the changing propagation environment. For example, if the received signal is organised as a series of bursts, the coefficients for the Wiener filter 16 may be updated for each burst of the received signal, such that the configuration of the Wiener filter 16 is as close to optimal as is possible for each burst.

The receiver 10 also includes an equaliser 18 for compensating for the effects of a propagation channel on the received signal and a demodulator 20 for demodulating the filtered and equalised received signal to recover transmitted data contained therein. Thus, after it has undergone filtering in the Wiener filter 16 to reduce interference, and after equalisation in the equaliser 18 to compensate for the effects of the propagation channel, the received signal is passed to the demodulator 20 to recover the transmitted data.

The processor 14 is configured to calculate the coefficients of the Wiener filter 16 using a matrix representation of complex signal arithmetic operations. Referring to FIG. 2, there is shown a representation of a propagation model used by the processor 14 to calculate the filter coefficients.

In the model illustrated in FIG. 2, a sequence sₙ of data symbols is transmitted through a propagation channel that can be described by a complex vector H representing the channel impulse response, which alters the transmitted sequence sₙ. In this model, the complex vector H represents the entire propagation channel between a transmitter which transmits the sequence sₙ and the receiver 10, and thus the complex vector H includes, for example, the effect of any pulse-shaping filters present in the transmitter or the receiver 10.

In the absence of any interference, symbols transmitted through the propagation channel are altered by the propagation channel before arriving at the receiver. This alteration of the transmitted signals can be represented as a linear filtering operation, expressed below as

$${x}_{n} = {\sum }_{l = 0}^{L} {H}_{l} {s}_{n - l}$$

The sequence sₙ can be considered to consist of real-valued data symbols, whilst the received signal xₙ can be considered to be a complex signal. In the embodiments presented in this description it will be assumed that the symbols sₙ are real-valued data symbols for the sake of clarity, but it will be apparent to those skilled in the art that the invention can equally be used in the case where the symbols sₙ are complex-valued data symbols.

The received symbols xₙ are affected by interference wₙ, which may be co-channel interference. This interference is additive in nature, and thus the resulting signal yₙ received by the receiver 10 illustrated in FIG. 1, is

yₙ=xₙ+wₙ

The signal yₙ is filtered by the Wiener filter 16 to cancel (or at least reduce the effect of) the interfering signal wₙ. The Wiener filter 16 has a transfer function that can be described by a complex vector F. Thus, the output zₙ of the Wiener filter 16 is

$${z}_{n} = {\sum }_{k = 0}^{M} {F}_{k} {y}_{n - k}$$

The processor 14 is configured to calculate coefficients for the Wiener filter 16 that minimise an error signal eₙ, which is the difference between the signal zₙ and the signal xₙ, i.e.

eₙ=zₙ−xₙ

By minimising the error signal eₙ the Wiener filter 16 can be optimised to cancel the interfering signal wₙ.

Unlike a conventional Wiener filter, the transfer function F of the Wiener filter 16 and the channel impulse response H are jointly estimated by the processor 14 in a single operation to minimise the error signal eₙ.

The process performed by the processor 14 to calculate the coefficients of the Wiener filter 16 is described below with the aid of a matrix representation of complex signal arithmetic operations.

In general a complex number can be considered to be a variable having two dimensions, a real dimension and an imaginary dimension. Thus, any complex number can be represented as a two-dimensional vector. For example, let

f=fᵣₑ+jfᵢₘ, z=zᵣₑ+jzᵢₘ and w=wᵣₑ+jwᵢₘ

Then

w=fz=wᵣₑ+jwᵢₘ=(fᵣₑ+jfᵢₘ)(zᵣₑ+jzᵢₘ)=fᵣₑzᵣₑ−fᵢₘzᵢₘ+j(fᵣₑzᵢₘ+fᵢₘzᵣₑ)

By treating the complex variable w as a variable in a two-dimensional space, the complex multiplication w=fz can be reformulated in a matrix form with

$$w = [ \begin{matrix}u \\ v\end{matrix} ] = [ \begin{matrix}{w}_{re} \\ {w}_{im}\end{matrix} ] , z = [ \begin{matrix}p \\ q\end{matrix} ] = [ \begin{matrix}{z}_{re} \\ {z}_{im}\end{matrix} ]$$

$$and$$

$$f = [ \begin{matrix}a & b \\ c & d\end{matrix} ] = [ \begin{matrix}{f}_{re} & - {f}_{im} \\ {f}_{im} & {f}_{re}\end{matrix} ]$$

This matrix transformation technique is used by the processor 14 to calculate the filter coefficients for the Wiener filter 16, as will be described below.

The transfer function H of the composite propagation channel can be modelled as a complex filter with L+1 complex coefficients. The received signal in the absence of interference is

$${x}_{n} = {\sum }_{l = 0}^{L} {H}_{l} {s}_{n - l} = {\sum }_{l = 0}^{L} [ \begin{matrix}{h}_{l} \\ {g}_{l}\end{matrix} ] {s}_{n - l}$$

Similarly, the transfer function F of the Wiener filter 16 can be modelled as a complex filter with M+1 coefficients, and the relationship between the filter output zₙ and the input yₙ can be written in matrix form as

$${z}_{n} = {\sum }_{k = 0}^{M} {F}_{k} {y}_{n - k} = {\sum }_{k = 0}^{M} [ \begin{matrix}{a}_{k} & {b}_{k} \\ {c}_{k} & {d}_{k}\end{matrix} ] [ \begin{matrix}{p}_{n - k} \\ {q}_{n - k}\end{matrix} ]$$

The error signal eₙ, which the processor 14 aims to minimise in order to reduce interference can be represented as

$${e}_{n} = {z}_{n} - {x}_{n} = {\sum }_{k = 0}^{M} [ \begin{matrix}{a}_{k} & {b}_{k} \\ {c}_{k} & {d}_{k}\end{matrix} ] [ \begin{matrix}{p}_{n - k} \\ {q}_{n - k}\end{matrix} ] - {\sum }_{l = 0}^{L} [ \begin{matrix}{h}_{l} \\ {g}_{l}\end{matrix} ] {s}_{n - l}$$

Expanding this summation yields

$${e}_{n} = [ \begin{matrix}{a}_{0} & {b}_{0} … {a}_{M} & {b}_{M} & {h}_{0} … {h}_{L} \\ {c}_{0} & {d}_{0} … {c}_{M} & {d}_{M} & {g}_{0} … {g}_{L}\end{matrix} ] [ \begin{matrix}{p}_{n} \\ {q}_{n} \\ … \\ {p}_{n - M} \\ {q}_{n - M} \\ - {s}_{n} \\ … \\ - {s}_{n - L}\end{matrix} ] = A [ \begin{matrix}{p}_{n} \\ {q}_{n} \\ … \\ {p}_{n - M} \\ {q}_{n - M} \\ - {s}_{n} \\ … \\ - {s}_{n - L}\end{matrix} ]$$

The matrix A contains 2 rows, each of (2M+L+3) elements, namely the M+1 Wiener filter coefficients in 2×2 matrix form and the L+1 coefficients of the composite channel H. The Wiener filter coefficients and the channel coefficients are estimated by the processor 14 to perform decoding of the transmitted symbol sequence sₙ.

It is common for wireless communication systems to transmit a known sequence (a “training sequence”) over the propagation channel to estimate the channel impulse response of the propagation channel. For example, when a GSM training sequence is being transmitted, the transmitted symbol sequence sₙ contains a known sequence of K+1 symbols. In the case of the GSM system, the training sequence is 26 bits long (i.e. K+1=26), with each bit of the training sequence being known.

The received signal

$${y}_{n} = [ \begin{matrix}{p}_{n} \\ {q}_{n}\end{matrix} ]$$

and the transmitted training sequence symbols sₙ are known.

As there are a number K+1 of known training sequence symbols, a number N+1, which is equal to K−L+1, of error symbols can be “stacked” together, to produce an error matrix E:

$$E = [ {e}_{n} … {e}_{n - N} ] \\ = AU \\ = [ \begin{matrix}{a}_{0} & {b}_{0} … {a}_{M} & {b}_{M} & {h}_{0} … {h}_{L} \\ {c}_{0} & {d}_{0} … {c}_{M} & {d}_{M} & {g}_{0} … {g}_{L}\end{matrix} ] [ \begin{matrix}{p}_{n} & & {p}_{n - 1} & … & {p}_{n - N} \\ {q}_{n} & & {q}_{n - 1} & & {q}_{n - N} \\ … & & … & & … \\ {p}_{n - M} & & {p}_{n - 1 - M} & & {p}_{n - M - N} \\ {q}_{n - M} & & {q}_{n - 1 - M} & & {q}_{n - M - N} \\ - {s}_{n} & & - {s}_{n - 1} & & - {s}_{n - N} \\ … & & … & & … \\ - {s}_{n - L} & & - {s}_{n - 1 - L} & & - {s}_{n - L - N}\end{matrix} ]$$

The matrix U contains the known complex received signal symbols and the known real training sequence symbols.

The coefficients of the Wiener filter 16 are calculated by minimising the sum of the squared magnitudes of errors eₙ . . . e_{n-N}

ε=tr(EE^{T})=tr(AUU^{T} A^{T})=tr(AΦA^{T}),

where Φ=(UU^{T}), tr( ) denotes the trace of the matrix and the matrix UU^{T} is symmetrical and positive definite. To avoid a trivial solution to this minimisation, a constraint is imposed that AA^{T}=I₂ (the two dimensional identity matrix). The matrix A is the solution of the equation

ΦA^{T}=A^{T} Λ,

where

$$Λ = [ \begin{matrix}{λ}_{0} & 0 \\ 0 & {λ}_{1}\end{matrix} ]$$

and λ₀, λ₁ are the two smallest eigenvalues of Φ.

The columns of the matrix A that solve this equation are the two eigenvectors of Φ which correspond to the two smallest eigenvalues of Φ. The coefficients of the Wiener filter 16 are calculated by the processor 14 in this way. The first 2M+2 columns of matrix A obtained in this way represent the coefficients of the Wiener filter 16 in matrix form. The following L+1 columns of matrix A represent the estimated channel impulse response coefficients of the propagation channel H.

The receiver 10 may be implemented as discrete hardware components, or may be implemented using a suitably-programmed device such as a digital signal processor (DSP), field programmable gate array (FPGA) or the like. Alternatively, the receiver may be implemented as a software program configured to run on an appropriate general purpose processor.

1. A receiver for receiving a signal transmitted through a propagation channel, the receiver comprising an antenna for receiving the signal, a processor for processing the received signal and a filter for filtering the received signal, wherein the processor is configured to calculate coefficients for configuring the filter and an estimated channel impulse response for the propagation channel.

2. A receiver according to claim 1 wherein the filter coefficients and estimated channel impulse response are calculated in a single operation.

3. A receiver according to claim 1 wherein the processor is configured to calculate the coefficients for configuring the filter on the basis of a known sequence contained in the transmitted signal.

4. A receiver according to claim 3 wherein the known sequence comprises a training sequence.

5. A receiver according to claim 1 wherein the processor is configured to calculate filter coefficients which minimise the difference between the filtered received signal and an expected interference-free received signal.

6. A receiver according to claim 1 wherein the filter comprises a Wiener filter.

7. A method for reducing interference in a signal received by a receiver through a propagation channel, the method comprising calculating filter coefficients for a filter and an estimated channel impulse response for the propagation and configuring the filter using the coefficients so calculated such that the received signal can be filtered by the filter to reduce interference.

8. A method according to claim 7 wherein the filter coefficients and estimated channel impulse response are calculated in a single operation.

9. A method according to claim 7 wherein the coefficients for configuring the filter are calculated on the basis of a known sequence contained in the transmitted signal.

10. A method according to claim 9 wherein the known sequence comprises a training sequence.

11. A method according to claim 7 wherein filter coefficients which minimise the difference between the filtered received signal and an expected interference-free received signal are calculated.

12. A method according to claim 7 wherein the filter comprises a Wiener filter.

13. (canceled)

14. (canceled)
